(19) United States
(12) Patent Application Publication
(10) Pub. No.: US 2007/0138689 A1
(43) Pub. Date: Jun. 21, 2007

(54) Wood-Polymer Composites And Additive Systems Therefor

(75) Inventors: Juan M. Bravo, Copley, OH (US); Larry J. Baldwin, Copley, OH (US)

Correspondence Address: RANKIN, HILL, PORTER & CLARK, LLP, 925 EUCLID AVENUE, SUITE 700, CLEVELAND, OH, 44115-1405, US

(73) Assignee: Ferro Corporation, Cleveland, OH (US)

(21) Appl. No.: 11/679,216

(22) Filed: Feb. 27, 2007

Related U.S. Application Data
(62) Division of application No. 10/979,864, filed on Nov. 2, 2004.

(51) Int. Cl. B29C 47/00

(52) U.S. Cl. 264/211; 524/27

(57) ABSTRACT

The present invention provides a method of forming a wood-polymer composite structure and additive systems for use therein. The method of the invention includes extruding a heated mixture that includes from about 20 wt % to about 80 wt % by weight of a thermoplastic polymer, from about 20 wt % to about 80 wt % by weight of a cellulosic filler material, and from about 0.1 wt % to about 10 wt % by weight of an additive system. The additive system according the invention includes a 12-hydroxystearic acid salt or amide.

### BACKGROUND OF THE INVENTION

1. Field of Invention

The present invention relates to a method of forming wood-polymer composite structures and additive systems for use therein.

2. Description of Related Art

For many years, thermoplastic polymers have been melt-mixed with cellulosic filler materials such as saw dust and extrusion molded to form composite “plastic wood” or “synthetic lumber” products, hereinafter generally referred to as “wood-polymer composites” (“WPC”). Structures (e.g., deck boards) formed of wood-polymer composites tend to be lighter in weight and significantly more moisture resistant than similarly sized structures formed solely of natural wood. In addition, wood-polymer composite structures can be formed from recycle streams of thermoplastic polymers and cellulosic fillers, which helps reduce the demand for natural wood and virgin polymer and thus aids in resource conservation.

The output rate determinative step in the production of wood-polymer composite structures is the rate at which such material can be extruded. If the extrusion rate is too high, the surface appearance of the resultant structure tends to be commercially unacceptable. In order to be commercially acceptable, the surface of a wood-polymer composite structure must be smooth, so as to approximate the surface of natural wood.

A variety of internal and external lubricants and/or release agents are used in production of wood-polymer composite structures in an effort to increase output rate. The most commonly used additive system in wood-polymer composites is a combination of a metal stearate, typically zinc stearate, and a synthetic wax, typically ethylene-bis-stearamide (hereinafter “EBS”) wax. This conventional additive system allows for an acceptable output rate and a commercially acceptable surface appearance.

While the use of a zinc stearate/EBS wax additive system does facilitate adequate extrusion or molding output rates, it also presents certain disadvantages. For example, there is a significant amount of scrap material generated during the production of wood-polymer composite structures. Ideally, this material would simply be reprocessed. However, scrap material containing zinc stearate and EBS wax presents difficulties in reprocessing because the surface appearance in the resulting wood-polymer composite structure may be less than ideal. Moreover, the output rate provided by a zinc stearate/EBS wax additive system is not optimal. Thus, there remains substantial room for improvement in the art.

### BRIEF SUMMARY OF THE INVENTION

The present invention provides a method of forming a wood-polymer composite composition, the wood-polymer composite composition formed by such method, articles formed by such method, additive systems for use in the compositions, and methods and articles of the invention. The method of the invention comprises extruding a heated mixture that comprises from about 20% to about 80% by weight of a thermoplastic polymer, from about 20% to about 80% by weight of a cellulosic filler material, and from about 0.1% to about 10% by weight of an additive system. The additive system according the invention comprises a first lubricant which may be either a salt or an amide of 12-hydroxystearic acid.

Use of the method and additive system according to the invention facilitates the production of highly filled wood-polymer composite structures at very high output rates while at the same time ensuring that such structures exhibit a commercially acceptable surface appearance. Moreover, the method and additive system according to the invention facilitate the reprocessing of scrap material generated during the production of wood-polymer composite structures without degrading the surface appearance of the resultant wood-polymer composite structures.

The foregoing and other features of the invention are hereinafter more fully described and particularly pointed out in the claims, the following description setting forth in detail certain illustrative embodiments of the invention, these being indicative, however, of but a few of the various ways in which the principles of the present invention may be employed.

### DETAILED DESCRIPTION OF THE INVENTION

As noted above, the method of the invention involves extruding a heated mixture that comprises from about 20% to about 80% by weight of a thermoplastic polymer, from about 20% to about 80% by weight of a cellulosic filler material, and from about 0.1% to about 10% by weight of an additive system. Each of these components is separately discussed below.

THERMOPLASTIC POLYMER. Virtually any thermoplastic polymer can be used in accordance with the present invention. Suitable thermoplastic polymers include, for example, polyamides, vinyl halide polymers, polyesters, polyolefins, polyphenylene sulfides, polystyrenes, polyoxymethylenes and polycarbonates. The thermoplastic polymer component of the mixture can comprise a single homopolymer or copolymer, or a combination of two or more different homopolymers or copolymers. The primary requirement for the thermoplastic polymer is that it retain sufficient thermoplastic properties to permit melt blending with the cellulosic filler material and permit effective formation into shaped articles by conventional extrusion molding processes. Thus, minor amounts of thermosetting polymers may also be included in the mixture provided that the essential properties are not adversely affected. Both virgin and recycled (post-consumer and/or reprocessed scrap) polymers can be used. In view of cost and ease of processing, polyolefins are presently the preferred thermoplastic polymers for use in the invention.

As used herein, the term polyolefin refers to homopolymers, copolymers and modified polymers of unsaturated aliphatic hydrocarbons. Polyethylene and polypropylene are the most preferred polyolefins for use in the invention, however it is envisioned to use polyvinyl chloride and polystyrene as well. High-density polyethylene (HDPE) is particularly preferred and, for economic and environmental reasons, regrinds of HDPE from bottles and film are most particularly preferred.

The mixture comprises from about 20% to about 80% by weight of one or more thermoplastic polymers. More preferably, the mixture comprises from about 30% to about 60% by weight of one or more thermoplastic polymers. In the presently most preferred embodiment of the invention, the mixture comprises from about 30% to about 40% by weight of one or more thermoplastic polymers, most preferably HDPE.

CELLULOSIC FILLER MATERIAL. The mixture preferably comprises from about 20% to about 80% by weight of one or more cellulosic filler materials. More preferably, the mixture comprises from about 25% to about 70% by weight of one or more cellulosic filler materials. In the presently most preferred embodiment of the invention, the mixture comprises from about 45% to about 55% by weight of one or more cellulosic filler materials, most preferably oak wood fiber.

The cellulosic filler material component may comprise reinforcing (high aspect ratio) fillers, non-reinforcing (low aspect ratio) fillers, and combinations of both reinforcing and non-reinforcing fillers. The term “aspect ratio” refers to the ratio of the length of the filler particle to the effective diameter of the filler particle. High aspect ratio fillers offer an advantage, that being a higher strength and modulus for the same level of filler content. The use of cellulosic filler materials is advantageous for several reasons. Cellulosic filler materials can generally be obtained at relatively low cost. Cellulosic filler materials are relatively light in weight, can maintain a high aspect ratio after processing in high intensity thermokinetic mixers, and exhibit low abrasive properties, thus extending machine life.

The cellulosic filler material may be derived from any cellulose source, including wood/forest and agricultural by-products. Thus, the cellulosic filler material may comprise, for example, hard wood fiber, soft wood fiber, hemp, jute, rice hulls, wheat straw, and combinations of two or more of these. Suitable wood products include fibers or flours of woods including oak, pine, poplar, cedar, cottonwood, maple, apple, cherry, mahogany, and other woods for which recycle streams are readily available.

In some applications, it may be desirable for the cellulosic filler material to comprise a blend of a major portion of a high aspect ratio fiber, such as a hard wood fiber, and a minor portion of a low aspect ratio fiber. Throughout the specification and in the appended claims, the term “major portion” means 50% or more by weight and “minor portion” means less than 50% by weight. It will be appreciated that high aspect ratio fibers are generally more difficult to process and therefore may be less desirable in some applications in which processing speed and efficiency are particularly important considerations.

Inorganic fillers, such as glass fibers, carbon fibers, talc, mica, kaolin, calcium carbonate, potassium carbonate, and the like, may also be included as an optional supplement to the cellulosic filler material. In addition, other organic fillers, including polymeric fiber, may also be used. The total filler content of the mixture (i.e., the sum of all cellulosic filler materials and other inorganic and/or organic fillers) may comprise up to about 80% of the mixture by weight. Preferably, inorganic fillers alone comprise up to about 50 wt % of the mixture, more preferably up to about 30 wt %, and most preferably up to about 10 wt %.

ADDITIVE SYSTEM. The additive system according to the invention includes one or more lubricants suitable for use in fabricating wood polymer composite (WPC) articles, e.g., by extrusion, injection molding, or other known methods. In particular, the additive system comprises a first lubricant selected from the group consisting of a salt of 12-hydroxystearic acid and an amide of 12-hydroxystearic acid, and combinations thereof. 12-hydroxystearic acid is derived from castor oil, and formally has the formula 12-hydroxy cis-9-octadecanoic acid, an 18-carbon carboxylic acid. Castor oil is the only naturally occurring source from which a 12-hydroxy-substituted fatty acid may be derived. Amides and metal salts of 12-hydroxystearic acid useful herein include N-(2-hydroxyethyl)12-hydroxystearamide; N,N′-(ethylene bis)12-hydroxystearamide; N,N′,N″-(propylene tris)12-hydroxystearamide; N,N′,N″,N′″-(butene tetrakis)12-hydroxystearamide; Ca(12-hydroxystearate)₂; Mg(12-hydroxystearate)₂; Zn(12-hydroxystearate)₂; Al(12-hydroxystearate); Al(12-hydroxystearate)₃; and isopropoxypropylamine 12-hydroxystearamide.

The preferred lubricants are N-(2-hydroxyethyl)12-hydroxystearamide and N,N′-(ethylene bis)12-hydroxystearamide, which are commercially available from CasChem, a division of Rutherford Chemicals LLC, Bayonne, N.J., under the product names Paricin® 220 and Paricin® 285, respectively. The products are also available from Oleo Chemie GmbH of Hamburg, Germany under the names Oleocin® 100 and Oleocin® 140, respectively.

Stearic acid esters of polyethylene glycols are also useful in the practice of the present invention, for example generally stearic acid monoesters of polyethylene glycols. The useful polyethylene glycols have a molecular weight of about 100 to about 10000. Such PEG esters of stearic acid include the monostearate of polyethylene glycol 100, the monostearate of polyethylene glycol 500, the monostearate of polyethylene glycol 1000, for example. Blends of such PEG esters are also useful. One specific ester is MAPEG S40, which is a monostearate of polyethylene glycol containing about 17-27% free polyethylene glycol, and is commercially available from BASF Corporation, Mount Olive N.J.

The inventive additive system may also include portions of conventional lubricants, for example metal stearates such as zinc stearate, calcium stearate, and magnesium stearate. Other stearic acid derivatives such as ethylene-bis-stearamide (EBS), ethylene bis cocamide (EBC), and ethylene bis lauramide (EBL). Esters such as pentaerythritol adipate stearate (PAS), available as G70S from Cognis North America, of Cincinnati, Ohio, are suitable. Further, also suitable is Glycolube® WP 2200 from Lonza, Inc., Fairlawn, N.J., which is believed to be about 90 wt % of ethylene bis cocamide (EBC), and which is free of metal stearates.

Castor oil (“CO”), whether unmodified, fully hydrogenated (“HCO”), or partially hydrogenated (“PHCO”), cannot be successfully used as the sole lubricant in the additive system, but it can constitute a major portion of the additive system. Thus, the present invention, as evidenced by the above formulas and embodiments, envisions the use of castor oil (unmodified, fully, or partially hydrogenated) as a portion of the additive system. The castor oils useful in the practice of the present invention include those where the double bonds are partially hydrogenated, for example, to the extent of about 70% or about 80%. These partially hydrogenated castor oils are available as Castorwax® MP-70 or MP-80, respectively, also available from CasChem. Other hydrogenation levels are possible also, such as about 50% or about 60%. However, fully hydrogenated castor oil is often more advantageous.

Although a salt or amide of 12-hydroxystearic acid may be used alone in the additive system, the other disclosed lubricants can be used together with it in a weight ratio of about 10:90 to about 90:10. For example, an additive system may comprise about 50 to about 80 wt % of a first lubricant such as a salt or amide of 12-hydroxystearic acid and about 20 to about 50 wt % of a second lubricant such as a PEG stearamide. Another additive system may comprise about 20 to about 40 wt % of N-(2-hydroxyethyl)12-hydroxystearamide or N,N′-(ethylene bis)12-hydroxystearamide and about 60 to about 80 wt % of CO, HCO or PHCO. In other embodiments, the total of all castor oils (CO, HCO, PHCO) in the additive system is about 5 wt % to about 25 wt %, more preferably about 8 wt % to about 12 wt %, and most preferably about 10 wt %. When it is present, WP 2200 comprises about 5 wt % to about 15 wt %, and preferably about 9 to about 11 wt % of the additive system.

In general, these conventional lubricants, when used, typically comprise from about 5 wt % to about 80 wt % of the additive system. The presently most preferred embodiment of the additive system includes both N,N′-(ethylene bis)12-hydroxystearamide and fully hydrogenated castor oil (HCO). The weight ratio of N,N′-(ethylene bis)12-hydroxystearamide to HCO may be 10:90 to about 90:10, preferably about 20:80 to about 80:20, and most preferably, about 30:70 to about 70:30.

Coupling Agents. A coupling agent is a compound capable of reacting with and binding to both a reinforcing filler and a resin matrix of a composite material. In the present context, polyolefins are generally non-polar, while cellulosic fibers are polar, owing to the presence of hydroxyl groups on cellulose units. Suitable coupling agents contain both polar and non-polar moieties. Useful coupling agents herein include modified polyolefins, depending on the thermoplastic material used in the wood polymer blend. A modified polyethylene is typically used in a polyethylene-wood composite; while a modified polypropylene is typically used in a polypropylene-wood composite. Maleated polypropylene and maleated polyethylene are two typical examples. A variety of polyethylene-specific coupling agents are useful herein, including those sold by Equistar Company of Newark, N.J. under the Integrate® NE or NP names, as shown in the table below.

| | Melt Index | Density | | Anhydride |
|---|---|---|---|---|
| Product | (g/10 min) | (g/cc) | Base Resin | Level |
| NE 556-004 | 3.8 | 0.956 | HDPE | High |
| NE 558-004 | 3.9 | 0.958 | HDPE | Very High |
| NE 433-003 | 2.7 | 0.933 | LLDPE | High |
| NE 534-003 | 2.6 | 0.934 | LLDPE | Very High |
| NE 542-013 | 13 | 0.943 | LLDPE | Very High |
| NE 556-P35 | 3.8 | 0.956 | HDPE | High |
| NE 558-P35 | 3.9 | 0.958 | HDPE | Very High |
| NE 542-P35 | 13 | 0.943 | LLDPE | Very High |
| NP 406-020 | 20.0 | 0.91 | PP | High |
| NP 507-030 | 29.0 | 0.91 | PP | Very High |
| NP 594-008 | 8.0 | 0.89 | PP | Very High |

The aforementioned coupling agents can be used at a loading of about 0.1 to about 10 wt % as a percentage of the overall wood polymer composite composition. Preferably, the coupling agents are used at a loading of 0.1 to 2.0 wt % of the overall wood polymer composite composition. Despite the superior strength properties often afforded by the use of coupling agents, the use of zinc stearate or calcium stearate with coupling agents can detract from the benefits generally realized by the use of coupling agents, and such combinations are not preferred.

The use of a lubricant such as N-(2-hydroxyethyl)12-hydroxystearamide or N,N′-(ethylene bis)12-hydroxystearamide along with a coupling agent can provide an unexpected synergistic increase in the rate at which wood-polymer composites may be extruded without degrading the surface appearance of the wood-polymer composite. Further benefits include improvements in flexural strength and flexural modulus, as measured in accordance with ASTM D-790, as well as improvements in resistance to water absorption. Further, retention of these properties after soaking then drying is also improved over prior art compositions. Without being bound by any theory, it is believed that this unexpected synergy is the result of the presence of additives that exhibit both polar and non-polar moieties. The additive system according to the invention provides a balance that facilitates the maximum output without detrimentally affecting surface appearance.

A wood-polymer composite extruded article can be made by melt mixing at a temperature sufficient to flow a thermoplastic polymer and extruding through an extruder die any of the disclosed melt blends one or more times. The invention herein envisions single-pass or multiple-pass extrusion. In the first-pass examples herein, powdered ingredients (wood flour, thermoplastic, fillers and additive system) are gravity fed into a volume extruder and pellets of a homogeneous composition are thus formed. Using such an extruder, parameters outside the effective control of the skilled artisan (moisture levels, stickiness of the lubricant, clumping powder in the hopper) may have an undue influence on physical properties of the extrudate after a single pass. However, the second pass begins with already homogeneous pellets of relatively uniform size. Property and output rate fluctuations due to imperfect mixing are largely eliminated when the pellets are melted and re-extruded in a second pass. Hence, second-pass results are more reproducible. The inventors herein believe that improvements in second-pass properties are more important than improvements in first-pass properties. Nevertheless, improvements in first-pass properties are sometimes realized, and desirable, as some fabricators will extrude a WPC article using only a single extrusion pass.

The inventors herein have discovered that the use of a 12-hydroxystearic acid amide or salt may improve the lubricant performance of a substance that would not otherwise be useful as a lubricant. Accordingly, the addition of a 12-hydroxystearic acid amide or salt to an additive system can improve the performance of the additive system and improve the properties of the WPC made therewith. More plainly, in some cases, the addition of a 12-hydroxystearic acid derivative can make a bad lubricant into a better lubricant. Substances that would not otherwise be used as a lubricant can now be used as a lubricant.

Another surprising result obtained through the use of the additive system according to the invention is the ability to reprocess scrap material without observing a decline in surface appearance of the resulting wood-polymer composite structure. If necessary, additional amounts of the additive system can be added during melt mixing in the extruder.

The present invention also provides a method of forming a wood-polymer composite article. The method comprises heating a mixture comprising from about 20% to about 80% by weight of a thermoplastic polymer, from about 20% to about 80% by weight of a cellulosic filler material and from about 0.1% to about 10% by weight of an additive system, extruding the heated mixture through a die (single pass) to form the article and cooling the article. A single pass through the extruder is sometimes employed either to melt and blend powdered ingredients resulting in a final extruded article, or to blend such ingredients into pellets, an intermediate product, which may be sold to another fabricator of WPC articles. However, a fabricator of WPC articles may begin with powdered ingredients, extrude them once to make pellets, and remelt such pellets through a second pass extrusion to facilitate more consistent properties and a more homogeneous product than sometimes results from a single pass extrusion.

Alternatively, the heated mixture, either beginning with powdered ingredients, or previously extruded pellets, can be used to form articles by injection molding. Any wood polymer composition including any additive system disclosed herein may be used in the methods described herein.

Wood-polymer composite structures formed in accordance with the invention can be used in place of natural wood structures in a variety of applications, provided that the strength requirements of the application do not exceed the physical properties of the wood-polymer composite structure. Exemplary structures include outdoor decking and planking, dimensional lumber, decorative moldings, picture frames, furniture, window moldings, window components, door components and roofing systems.

Several metal salts of 12-hydroxystearate, including Zn(12-hydroxystearate)₂ and Al(12-hydroxystearate)₃, are useful as lubricants herein. Processes for making these salts are envisioned. For example, a process for preparing zinc salts of 12-hydroxystearic acid, comprises heating 12-hydroxystearate to about 100° C. to about 150° C., preferably about 130° C. to about 140° C.; contacting the 12-hydroxystearate with ZnO; contacting the 12-hydroxystearate and ZnO with an organic acid to form a reaction mixture; and heating the reaction mixture to about 140 to about 180° C., preferably 150 to about 160° C. The starting mole ratio of 12-hydroxystearate to ZnO may be about 10:1 to about 1:1. Formic acid, acetic acid, oxalic acid, and butyric acid may be used.

To make Zn(12-hydroxystearate)₂, 12-hydroxystearic acid (50.01 g, 0.166 mol) was placed into a reactor and heated to 135° C. Zinc oxide (6.68 g, 0.082 mol) was added to the reactor. Formic acid (90%, 0.10 g, 0.002 mole) was added to the ZnO and 12-hydroxystearic acid to form a reaction mixture. The temperature fell as the reaction proceeded. The reaction temperature was increased to 155-160° C. The reaction mixture, after turning amber in color, cleared after 40 minutes. The contents of the reactor was cast into a crystallization dish and cooled to room temperature. The product, Zn(12-hydroxystearate)₂, weighed 53.32 grams for a yield of 97.8%. The melting point was 144-145° C.

Similarly, a process for making aluminum salts of 12-hydroxystearate is envisioned. Such a process comprises contacting 12-hydroxystearate with water heating to about 65 to about 80° C., contacting the water and 12-hydroxystearate with sodium aluminate to form a first reaction mixture, contacting the first reaction mixture with aluminum sulfate to form a second reaction mixture. The starting mole ratio of sodium aluminate to 12-hydroxystearate may be about 1:1 to about 10:1. The starting mole ratio of aluminum sulfate to 12-hydroxystearate may be about 20:1 to about 100:1.

To make Al(12-hydroxystearate)₃, 800 grams of water was heated in a reactor to 160° F. (66° C.). 12-hydroxystearic acid (109.49 g, 0.365 mol) was added to the water and stirred. Sodium aluminate (45% solution, 20.87 g, 0.0572 mol) was added to the reactor, and the first reaction mixture was stirred at 580 RPM and 160° F. for 15 minutes. Aluminum sulfate (8% solution, 31.13 g, 0.00729 mol) was added to the reactor to form a second reaction mixture. The second reaction mixture was mixed and cooled to room temperature. The solid reaction product was powdered in a mortar and pestle and washed four times with one liter of distilled water until the last wash had the same conductivity of the distilled water. The precipitate was crystallized and dried at 105° C. over night. The final product, Al(12-hydroxystearate)₃, weighed 110.48 grams, a yield of 98.1%.

### EXAMPLES

The following examples are intended only to illustrate the invention and should not be construed as imposing limitations upon the claims.

### Example 1

The amounts of the various components (wood flour, thermoplastic, filler, additive system) shown in weight percent in Table 1 below were melt mixed together in a Leistritz 18 mm counter rotating extruder at a temperature of 174° C. and then extruded through a rectangular 0.125″×0.375″ die to form a lab test sample structure 3.2 mm (0.125″) thick and 9.6 mm (0.375″) wide (the length of the samples varied). The powdered ingredients were gravity fed through a volumetric feeder at 26% of maximum RPM on the first pass and at 18.5% on the second pass

Samples 1-4 are examples of WPCs using the inventive additive systems, while samples A and B are control (prior art) examples. Example B uses TPW 104, a lubricant commercially available from Struktol Company, Stow, Ohio. TPW 104 is believed to be a blend of aliphatic carboxylic acid salts and mono- and bis-amides. The extruder had five heating zones, held at temperatures of 160/165/175/175/175° C. Table 2 presents the processing parameters of the WPC including product output, output/power ratio, appearance characteristics, and strength testing. The WPC blends are measured for each parameter upon a first pass through the extruder, where powdered ingredients are melt mixed and extruded to form pellets, and upon a second pass through the extruder, where the previously extruded pellets are remelted to form an extruded article. Following submersion in water for seven days at 70° F., the second pass compositions are also tested for water absorption (water wt % gain after one and seven days). After drying for seven days at 70° F. and 50% relative humidity, the strength properties are retested to determine retention of post-soak and -dry properties. Some manufacturers of wood polymer composites use only a single pass to extrude powdered ingredients into an extruded article. However, it has been found that single-pass processing subjects the extruded article to wide variations in final properties because the characteristics of the starting ingredients, especially moisture of wood flour, are not controllable or even known by the process operator. A two-pass process is preferred, in which the first pass melts and extrudes powdered ingredients into pellets, which are then remelted and extruded in a second pass, which results in a very homogeneous composition, and extruded articles having optimal properties.

TABLE 1
Additive system lubricants and wood polymer composite
compositions

| Sample: | A (control) | Ex 1 | Ex 2 | B (control) | Ex 3 | Ex 4 |
|---|---|---|---|---|---|---|
| Additive System | 40% EBS | 60% 2HydEth | 70% Zn12 | TPW 104 | 30% EB | 30% EB |
| | | 12Hydroxy | HydSt | | 12Hyd | 12Hyd |
| | | Strmd | | | Strmd | Strmd |
| Lubricants | 60% ZnSt | 30% ZnSt | 20% EBS | | 70% HCO | 70% HCO |
| | | 10% CaSt | 10% CaSt | | | |
| Total powdered | | | | | | |
| ingredients (wt %) | | | | | | |
| Wood-Oak Flour | 49.9 | 49.9 | 49.9 | 48.8 | 49.9 | 48.9 |
| HDPE | 38.6 | 38.6 | 38.6 | 37.9 | 38.6 | 37.8 |
| Talc | 5.0 | 5.0 | 5.0 | 5.0 | 5.0 | 4.9 |
| CL52351 Grey | 2.0 | 2.0 | 2.0 | 1.9 | 2.0 | 1.9 |
| Color Conc | | | | | | |
| Maleated PE | 0.0 | 0.0 | 0.0 | 1.9 | 0.0 | 1.9 |
| Coupler | | | | | | |
| Lubricants | 4.5 | 4.5 | 4.5 | 4.5 | 4.5 | 4.5 |

In Table 1, above, 2HydEth 12Hydroxy Strmd stands for N-(2-hydroxyethyl)12-hydroxystearamide; EB 12Hyd Strmd is N,N′-(ethylene bis)12-hydroxystearamide; Zn 12Hydroxy Stearate is Zn(12-hydroxystearate)₂; EBS stands for ethylene-bis stearamide; ZnSt is zinc stearate, CaSt is calcium stearate, and HCO is fully hydrogenated castor oil. The oak wood flour used is that available from any source, wherein the particle size distribution is as follows: 25-85% passes through a 250 micron mesh, 10-65% passes through a 180 micron mesh, and 0-25% passes through an 80 micron mesh. The wood flour is dried to less than 1.5% moisture before processing. Typical bulk density is 15 lbs/cubic foot (0.24 g/cc) for the flour used in these tests with a specific gravity of 33.7 lbs/cubic foot (0.54 g/cc) for hardwoods. HDPE is high density polyethylene, either virgin or recycled (reprocess scrap or post-consumer waste) having a density of about 0.935 to 0.975 g/cc, typically 0.955 g/cc. CL52531 gray color concentrate is a pigment commercially available from the Ferro Corporation of Stryker, Ohio. Maleated PE coupler is a maleated polyethylene coupling agent, for example Integrate® NE 542-004, from Equistar Company of Newark, N.J. Lubricants are the additive system disclosed herein.

TABLE 2
Processing parameters and strength testing results of the wood
polymer composite compositions including additive systems of Table 1.

| Sample: | A (control) | Ex 1 | Ex 2 | B (control) | Ex 3 | Ex 4 |
|---|---|---|---|---|---|---|
| 1st Pass Powder | | | | | | |
| RPM/Feed % high gear | 250/26 | 250/26 | 250/26 | 250/26 | 250/26 | 250/26 |
| g/min | 204 | 215 | 195 | 171 | 203 | 190 |
| Amps | 6.6 | 4.9 | 5.6 | 6.1 | 6.0 | 6.0 |
| Melt Pressure, psi | 866 | 478 | 668 | 780 | 680 | 770 |
| Melt Temp., deg C. | 169 | 165 | 169 | 172 | 168 | 173 |
| Gram/amp Ratio | 30.9 | 43.9 | 34.8 | 28.0 | 33.8 | 31.7 |
| Surface-Edge Tear | 3 | 2 | 2 | 2 | 1 | 1 |
| Surface Texture | 3 | 3 | 3 | 3 | 3 | 3 |
| Flex Testing-ASTM D790 | | | | | | |
| 48 hr+ Cond. Strength, psi | 3,650 | 4,143 | 4,126 | 3794 | 3,992 | Not Av |
| Modulus (10\hat{ }5 psi) | 4.67 | 5.35 | 5.41 | 4.60 | 4.75 | Not Av |
| 2nd Pass Pellets | | | | | | |
| RPM/Feed % high gear | 250/18.5 | 250/18.5 | 250/18.5 | 250/18.5 | 250/18.5 | 250/18.5 |
| g/min | 142 | 170 | 113 | 119 | 119 | 135 |
| Amps | 5.9 | 4.6 | 4.8 | 5.2 | 4.8 | 5.5 |
| Melt Pressure (psi) | 668 | 250 | 470 | 628 | 418 | 596 |
| Melt Temp., deg C. | 170 | 167 | 173 | 173 | 170 | 174 |
| Gram/amp Ratio | 24.1 | 37.0 | 23.5 | 22.9 | 24.8 | 24.5 |
| Surface-Edge Tear | 2 | 1 | 2 | 2 | 1 | 1 |
| Surface Texture | 3 | 2 | 3 | 3 | 2 | 2 |
| Flex Testing-ASTM D790 | | | | | | |
| 48 hr+ Cond. Strength, psi | 3667 | 4309 | 4361 | 3727 | 4491 | 4999 |
| Modulus (10\hat{ }5 psi) | 4.99 | 5.73 | 6.01 | 4.60 | 5.63 | 5.73 |
| Water Abs and Property | | | | | | |
| Retention | | | | | | |
| Water Abs @ 1 day + 70° F. | 3.5 | 2.8 | 4.0 | 3.1 | 2.2 | 2.3 |
| (wt %) | | | | | | |
| Water Abs @ 7 days + 70° F. | 7.5 | 7.2 | 9.2 | 6.9 | 5.6 | 5.4 |
| (wt %) | | | | | | |
| Properties after 2 days | | | | | | |
| drying: | | | | | | |
| Flex Strength, psi | 3397 | 3865 | 3362 | 3454 | 3967 | 4506 |
| Flex Modulus, 10\hat{ }5 psi | 3.38 | 3.89 | 3.01 | 3.30 | 4.14 | 4.42 |

Product output can be measured in grams per minute, which is specific to a particular extruder set up. Another measure of output is grams per amp, which measures the power required to move a gram of extrudate through the extruder. It is desirable to have a high output rate while minimizing the amps (i.e., power) required for the particular output. However, when deciding priority of variables to optimize, it is often more important to improve strength properties and surface appearance than to maximize output.

In all examples, surface quality determinations were made by examining the surface appearance of the extruded material and assigning a grade according to a six-point scale. Both surface edge-tear and surface texture were rated. An edge-tear rating of 1 indicates that the edge was not torn at all, while a 6 represents very severe tear. Similarly, a surface texture of 1 is very smooth, while a 6 is very rough. Flexural strength and flexural modulus were tested with an Instron Universal Tester in accordance with ASTM D-790, where the crosshead speed was ½ inch per minute. The strength parameter “48 hr condition strength” is the flexural strength tested after 48 hours of conditioning the sample at 50% relative humidity and 73° F. Water abs is water absorption, measured as a percentage of water weight gain relative to the dry weight of a sample.

For reasons discussed previously, it is noted that the improvements of the inventive additive systems are more remarkable after the second pass extrusion (pellets→extruded article) than after the first pass extrusion (powdered ingredients→pellets).

### Example 2

Table 3 presents a series of WPC blends that differ only in the content of one lubricant in the additive system. Each blend contains 4.5 wt % of an additive system; all three additive systems contain 30 wt % of ethylene bis cocamide. As the second lubricant, samples 5, 6, and 7 contain 70 wt % isopropoxypropylamine cocamide; 70% isopropoxypropylamine stearamide, and 70% isopropoxypropylamine 12-hydroxystearamide, respectively. Across the series cocamide→stearamide→12-hydroxystearamide, it is evident that the processability as measured by grams/amp, improves markedly, both for the first and second passes. Perhaps more notably of the three first-pass samples and the three second pass samples, five out of six had poor appearance. On the second pass run of the sample 7, (isopropoxypropylamine 12-hydroxystearamide), the appearance improved to a 1 or 2, and the strength properties were superior.

TABLE 3
Effect of 12-hydroxy group addition

| | Sample: | | |
|---|---|---|---|
| | 5 | 6 | 7 |
| Additive System | 70% Isopropoxypropylamine | 70% Isopropoxypropylamine | 70% Isopropoxypropylamine |
| | cocamide | stearamide | 12-Hydroxystearamide |
| Lubricants | 30% Ethylene | 30% Ethylene | 30% Ethylene |
| | bis-cocamide | bis-cocamide | bis-cocamide |
| Total powder ingred. (wt %) | | | |
| Wood-Oak Flour | 49.9 | 49.9 | 49.9 |
| HDPE | 38.6 | 38.6 | 38.6 |
| Talc | 5.0 | 5.0 | 5.0 |
| CL52351 Grey Color Conc | 2.0 | 2.0 | 2.0 |
| Total Lubricants | 4.5 | 4.5 | 4.5 |
| 1st Pass Powder | | | |
| RPM/Feed % high gear | 250/26 | 250/26 | 250/26 |
| g/min | 113 | 203 | 192 |
| Amps | 6.2 | 9.4 | 7.7 |
| Melt Pressure, psi | 713 | 950 | 953 |
| Melt Temp., deg C | 173 | 176 | 169 |
| Gram/amp Ratio | 18.2 | 21.6 | 24.9 |
| Surface-Edge Tear | 4 | 6 | 5 |
| Surface Texture | 5 | 6 | 6 |
| Flex Testing-ASTM D790 | | | |
| 48 hr+ Cond. Strength, psi | Not Tested | Not Tested | Not Tested |
| Modulus (10\hat{ }5 psi) | Edge Torn | Edge Torn | Edge Torn |
| 2nd Pass Pellets | | | |
| RPM/Feed % high gear | 250/18.5 | 250/18.5 | 250/18.5 |
| g/min | 103 | 77 | 104 |
| Amps | 6.5 | 5.3 | 4.4 |
| Melt Pressure (psi) | 665 | 588 | 366 |
| Melt Temp., deg C | 178 | 176 | 174 |
| Gram/amp Ratio | 15.8 | 14.5 | 23.6 |
| Surface-Edge Tear | 4 | 4 | 1 |
| Surface Texture | 5 | 5 | 2 |
| Flex Testing-ASTM D790 | | | |
| 48 hr+ Cond. Strength, psi | Not Tested | Not Tested | 4,054 |
| Modulus (10\hat{ }5 psi) | Edge Torn | Edge Torn | 5.34 |
| Water Abs and Property Retention | | | |
| Water Abs @ 1 day + 70° F. (wt %) | Not Tested | Not Tested | 2.8 |
| Water Abs @ 7 days + 70° F. (wt %) | Edge Torn | Edge Torn | 6.6 |
| Properties after 2 days drying: | | | |
| Flex Strength, psi | Not Tested | Not Tested | 3580 |
| Flex Modulus, 10\hat{ }5 psi | Edge Torn | Edge Torn | 3.70 |

In plain terms, the addition of a 12-hydroxy group to an otherwise poor additive system can create a good additive system.

Additional advantages and modifications will readily occur to those skilled in the art. Therefore, the invention in its broader aspects is not limited to the specific details and illustrative examples shown and described herein. Accordingly, various modifications may be made without departing from the spirit or scope of the general inventive concept as defined by the appended claims and their equivalents.

1-16. (canceled)

17. A method for making a wood polymer composite comprising melt-mixing at a temperature sufficient to flow a thermoplastic polymer and extruding through a die a wood polymer composite comprising:
a. about 20 wt % to about 80 wt % of a thermoplastic polymer,
b. about 20 wt % to about 80 wt % of a cellulosic filler material, and
c. about 0.1 wt % to about 10 wt % of a lubricating additive system comprising
i. a first component selected from the group consisting of a salt of 12-hydroxystearic acid, an amide of 12-hydroxystearic acid, and combinations thereof, and
ii. a second component selected from the group consisting of calcium stearate, zinc stearate, aluminum stearate, magnesium stearate, ethylene bis stearamide, ethylene bis lauramide, ethylene bis cocamide, the monostearate of polyethylene glycol 100, the monostearate of polyethylene glycol 500, the monostearate of polyethylene glycol 1000, and combinations thereof.

18. A method for making a wood polymer composite comprising melt-mixing at a temperature sufficient to flow a thermoplastic polymer and extruding through a die a wood polymer composite of comprising:
a. about 30 wt % to about 40 wt % of a thermoplastic polymer,
b. about 45 wt % to about 55 wt % of a cellulosic filler material, and
c. about 3 wt % to 7 wt % of a lubricating additive system comprising
i. a first component selected from the group consisting of N-(2-hydroxyethyl) 12-hydroxystearamide and N,N′-(ethylene bis) 12-hydroxystearamide, N,N′,N″-(propylene tris)12-hydroxystearamide; and N,N′,N″, N′″-(butene tetrakis) 12-hydroxystearamide; Ca(12-hydroxystearate)₂, Mg(12-hydroxystearate)₂, Zn(12-hydroxystearate)₂, Al(12-hydroxystearate) and Al(12-hydroxystearate)₃, and isopropoxypropylamine 12-hydroxystearamide, and blends thereof, and
ii. a second component selected from the group consisting of calcium stearate, zinc stearate, aluminum stearate, magnesium stearate, ethylene bis cocamide, ethylene bis lauramide, ethylene bisstearamide, castor oil, partially hydrogenated castor oil and fully hydrogenated castor oil.

19-20. (canceled)

21. The method of claim 17, wherein the lubricating additive comprises about 10 to about 90 wt % of the first component and about 10 to about 90 wt % of the second component.

22. The method of claim 17, wherein the thermoplastic polymer is a polyolefin.

23. The method of claim 17, wherein the thermoplastic polymer is selected from the group consisting of recycled, scrap, post-consumer, virgin, and combinations thereof.

24. The method of claim 17, wherein the first component is selected from the group consisting of N-(2-hydroxyethyl) 12-hydroxystearamide; N,N′-(ethylene bis) 12-hydroxystearamide; N,N′,N″-(propylene tris) 12-hydroxystearamide; N,N′,N″,N′″-(butene tetrakis) 12-hydroxystearamide; isopropoxypropylamine 12-hydroxystearamide, and combinations thereof.

25. The method of claim 17, wherein the first component is selected from the group consisting of N-(2-hydroxyethyl) 12-hydroxystearamide; N,N′-(ethylene bis) 12-hydroxystearamide, and combinations thereof.

26. The method of claim 17, wherein the first component comprises about 20 wt % to about 40 wt % of N-(2-hydroxyethyl) 12-hydroxystearamide or N,N′-(ethylene bis)12-hydroxystearamide, and combinations thereof, and wherein the second component comprises about 60 wt % to about 80 wt % of castor oil.

27. The method of claim 17, wherein the lubricating additive system comprises about 30 wt % to about 70 wt % of N,N′-(ethylene bis)12-hydroxystearamide, and about 30 wt % to about 70 wt % of fully hydrogenated castor oil.

28. The method of claim 17, wherein the thermoplastic polymer is polypropylene, wherein the lubricating additive system comprises about 20 to about 80 wt % of a lubricant selected from the group consisting of N-(2-hydroxyethyl)12-hydroxystearamide; N,N′-(ethylene bis)12-hydroxystearamide, and combinations thereof; and wherein the second component is a castor oil hydrogenated to the extent of about 50% to about 80%, and wherein the wood polymer composite further comprises about 0.1 to about 10 wt % maleic anhydride-polypropylene coupling agent having a density of 0.89-0.91 and a melt index 8-29.

29. The method of claim 17, wherein the thermoplastic polymer is polyethylene, wherein the lubricating additive system comprises about 20 to about 80 wt % of a lubricant selected from the group consisting of N-(2-hydroxyethyl)12-hydroxystearamide; N,N′-(ethylene bis)12-hydroxystearamide, and combinations thereof; and wherein the second component is a castor oil hydrogenated to the extent of about 50% to about 80%, and wherein the wood polymer composite further comprises about 0.1 to about 10 wt % of a maleic anhydride-polyethylene coupling agent having a density of 0.93-0.98 and a melt index of 2.7-13.

30. The method of claim 18, wherein the lubricating additive system comprises about 20 wt % to about 40 wt % of N-(2-hydroxyethyl)12-hydroxystearamide or N,N′-(ethylene bis)12-hydroxystearamide, and combinations thereof, and wherein the second component comprises about 60 wt % to about 80 wt % of castor oil.

31. A method for making a wood polymer composite comprising melt-mixing at a temperature sufficient to flow a thermoplastic polymer and extruding through a die a wood polymer composite devoid of metal stearates comprising:
a. about 20 wt % to about 80 wt % of a thermoplastic polymer,
b. about 20 wt % to about 80 wt % of a cellulosic filler material, and
c. about 0.1 wt % to about 10 wt % of a lubricating additive system comprising
i. a first component selected from the group consisting of a salt of 12-hydroxystearic acid, an amide of 12-hydroxystearic acid, and combinations thereof,
ii. a second component selected from the group consisting of pentaerythritol adipate stearate, ethylene bis stearamide, ethylene bis lauramide, ethylene bis cocamide, the monostearate of polyethylene glycol 100, the monostearate of polyethylene glycol 500, the monostearate of polyethylene glycol 1000, and combinations thereof and
iii. a coupling agent selected from the group consisting of maleated polypropylene and maleated polyethylene, and combinations thereof.

32. A method for making a wood polymer composite comprising melt-mixing at a temperature sufficient to flow a thermoplastic polymer and extruding through a die a wood polymer composite comprising:
a. about 20 wt % to about 80 wt % of a thermoplastic polymer,
b. about 20 wt % to about 80 wt % of a cellulosic filler material, and
c. about 0.1 wt % to about 10 wt % of a lubricant selected from the group consisting of a salt of 12-hydroxystearic acid, an amide of 12-hydroxystearic acid, and combinations thereof, and
d. containing no other lubricating compositions.

33. The method of claim 32 wherein the lubricant is selected from the group consisting of N-(2-hydroxyethyl) 12-hydroxystearamide; N,N′-(ethylene bis) 12-hydroxystearamide; N,N′,N″-(propylene tris)12-hydroxystearamide; N,N′,N″,N′″-(butene tetrakis) 12-hydroxystearamide; isopropoxypropylamine 12-hydroxystearamide, and combinations thereof.

34. The method of claim 33 wherein the wood polymer composite further comprises 0.1 to 10 wt % of a coupling agent.

35. A method for making a wood polymer composite devoid of metal stearates and devoid of intentionally added castor oil comprising melt-mixing at a temperature sufficient to flow a thermoplastic polymer and extruding through a die a wood polymer composite, comprising:
a. about 20 wt % to about 80 wt % of a thermoplastic polymer,
b. about 20 wt % to about 80 wt % of a cellulosic filler material, and
c. about 0.1 wt % to about 10 wt % of a lubricating additive system lubricant is selected from the group consisting of N-(2-hydroxyethyl)12-hydroxystearamide; N,N′-(ethylene his) 12-hydroxystearamide; N,N′,N″-(propylene tris) 12-hydroxystearamide; N,N′,N″,N′″-(butene tetrakis)12-hydroxystearamide; isopropoxypropylamine 12-hydroxystearamide, and combinations thereof.

36. The method of claim 35, wherein the thermoplastic polymer is polypropylene and the wood polymer composite further comprises maleated polypropylene.

37. The method of claim 35, wherein the thermoplastic polymer is polyethylene and the wood polymer composite further comprises maleated polyethylene.

38. In the formulation of a wood polymer composite by melt mixing a thermoplastic polymer, a cellulosic filler material, and a lubricating additive system, wherein the lubricating additive system comprises
a. a first component selected from the group consisting of a salt of 12-hydroxystearic acid, an amide of 12-hydroxystearic acid, and combinations thereof, and
b. a second component selected from the group consisting of calcium stearate, zinc stearate, aluminum stearate, magnesium stearate, ethylene bis stearamide, ethylene bis lauramide, ethylene bis cocamide, the monostearate of polyethylene glycol 100, the monostearate of polyethylene glycol 500, the monostearate of polyethylene glycol 1000, and combinations thereof,
the improvement comprising controlling the flexural modulus, surface texture, surface edge tear, percent water absorption after one and seven days, and 48 hour conditioned strength without changing processing parameters by selectively altering only the identity and proportion of first and second components.
